(19) United States
(12) Patent Application Publication
(10) Pub. No.: US 2024/0368381 A1
(43) Pub. Date: Nov. 7, 2024

(54) Particulate filler with reduced dust formation, method for its preparation and its use

(71) Applicant: Gebrüder Dorfner GmbH & Co. Kaolin- und Kristallquarzsand-Werke KG, Hirschau (DE)

(72) Inventors: Marco Süß, Neunburg vorm Wald (DE); Kirstin Heyen, Hanbach (DE)

(73) Assignee: Gebrüder Dorfner GmbH & Co. Kaolin- und Kristallquarzsand-Werke KG, Hirschau (DE)

(21) Appl. No.: 18/649,874

(22) Filed: Apr. 29, 2024

(30) Foreign Application Priority Data
May 2, 2023 (DE) 10 2023 111 311.9

(51) Int. Cl. C08K 9/06; C09C 3/00

(52) U.S. Cl. CPC C08K 9/06; C09C 3/006; C01P 2004/61; C01P 2006/10; C08K 2201/005

(57) ABSTRACT

A method for the preparation of a particulate filler with slight dust formation suitable for use in composite materials, wherein the mean particle size of the filler measured by air jet sieving and/or Sedigraph is ≤300 μm and is characterised by the following steps: Providing carrier particles which have an average particle size measured by air jet sieving and/or Sedigraph≤ 300 μm, providing a silane, siloxane and/or silicone, providing a paraffin oil, preparing a liquid coating compound by mixing the silane, siloxane and/or silicone with the paraffin oil and optionally further components, coating the carrier particles with the coating compound in a mixing device. The invention also relates to a particulate filler with slight dust formation and the use of such a particulate filler as a filler in a casting slip and/or a composite material, i.e. also a composite material comprising a binder and such a filler.

### CROSS-REFERENCE TO RELATED APPLICATIONS

This application claims priority from German application no. 10 2023 111 311.9, filed on May 2, 2023, which is incorporated by reference herein to the extent that there is no inconsistency with the present disclosure.

### BACKGROUND OF THE INVENTION

The present invention relates to particles with reduced dust formation, as well as a method for their production. Possibilities for using particles with reduced dust formation are also disclosed.

Many inorganic materials are used in a wide variety of applications in particulate form. By way of example only, reference is made in this respect to cement, porcelain and composite materials with mineral fillers. In the context of the present invention, a composite material is simply understood to be a polymer containing an inorganic and/or organic filler. Of particular importance in this respect is quartz, which is widely used (for example in the form of sand) and is utilised in a variety of applications. Even though many of the inorganic substances used for these applications are normally harmless or pose only a low health risk, it has been found that their use in particulate form can pose a health risk, particularly due to inhalable dusts. For example, it was found that dust of varying quantities and grain sizes is produced when quartz-containing rocks are worked and processed. Fine quartz dust is considered a carcinogenic substance that can lead to silicosis and thus also cause lung cancer.

As this risk, according to current knowledge, is due to the small particle size of the fine dust particles and this no longer exists after further processing of the inorganic particulate materials into composite materials, for example, there is still a great demand for such particulate materials.

In particular, the demand for particulate materials with particularly small particle sizes has increased, as these make them appear particularly homogeneous when used in composite materials, for example, in addition to other advantages such as improved rheological behaviour and thus improved processing properties.

Fillers of different colours are also in demand. Coloured fillers can give a composite material a desired colour. Mixtures of differently coloured fillers can be used to give composite materials an appearance similar to natural stone such as granite. The colouring substances should always be firmly bonded to the particles of the filler in order to prevent these particles from being detached by the solvent contained in the binder, for example.

In addition, fillers based on renewable raw materials are increasingly being used. When processing these and setting a defined particle size range (e.g. around 0.1-0.5 mm), a considerable proportion of particles with a significantly smaller particle size is also always produced. This can often not be utilised, which makes such raw materials of the 0.1-0.5 mm fraction more expensive and is detrimental to the holistic solution approach. The fact that the proportion with a very small particle size is not utilised is partly due to the fact that these particles have a high specific surface area and/or are very absorbent. When used in composite materials, this leads to increased binder or resin requirements. This in turn has cost disadvantages due to the high cost of the binder/resin. In addition, the processability is severely restricted, as the viscosity of the casting slip increases significantly when using such particles, which severely restricts the mould formation process or even prevents the production of very complex moulds, as the casting slip cannot flow into remote sections of the mould.

There is therefore a need to provide a particulate filler with a small average particle size that forms as little dust as possible during handling. In addition, such a filler should preferably be coloured and/or dyeable. It should also be suitable for the production of casting slips for composite materials.

This problem is solved by the objects of the independent patent claims.

### SUMMARY OF THE INVENTION

One solution to the problem underlying the invention consists in a method for producing a particulate filler with slight dust formation, which is suitable for use in composite materials, wherein the average particle size of the filler measured by air jet sieving and/or Sedigraph is ≤ 300 μm. In a preferred variant, a filler with an average particle size, measured by air jet sieving and/or Sedigraph, of 25-100 μm is used, further preferably 45-100 μm. In a further complementary or alternative preferred embodiment, the average particle size, measured by air jet sieving and/or Sedigraph is in the section of <45 μm, especially <25 μm, preferably 0.1-45 μm, particularly preferably 0.1-25 μm. The particle size distributions of the fillers can be monomodal to multimodal.

The method is characterised by the following steps:
provision of carrier particles which have an average particle size measured by air jet sieving and/or Sedigraph≤300 μm,
provision of a silane, siloxane and/or silicone,
provide a paraffin oil,
preparation of a liquid coating compound by mixing the silane, siloxane and/or silicone with the paraffin oil and optionally other components,
coating the carrier particles with the coating compound in a mixing device. It has been shown that dust formation can be reduced particularly easily by such a process and a coating can be applied to the carrier particles.

In a preferred variant, carrier particles with an average particle size, measured by air jet sieving and/or Sedigraph, of 25-100 μm are used, further preferably 45-100 μm. In a further complementary or alternative preferred embodiment, the average particle size, measured by air jet sieving and/or Sedigraph, is in the order of <45 μm, especially <25 μm, preferably 0.1-45 μm, particularly preferably 0.1 25 μm. The particle size distributions of the carrier particles used can be monomodal to multimodal. It has been shown that such carrier particles are particularly suitable for the production of fillers.

In addition to the components described above, the coating compound may contain further components. One of the optional further components is preferably selected from a group comprising pigments, rheological additives, adhesive agent, hydrophobing agents, hydrophilising agents and pH additives. In this context, rheological additives are to be understood as substances with which the flow behaviour can be adjusted. For example, such substances have the effect of making the surfaces of the filler particles smoother so that the particles can slide along each other more easily. Similarly, the term pH additive should be understood to mean that these substances can be used to adjust the pH of the particles (at least in the area of their surface). This can, for example, have the effect of improving bonding with a binder used to produce a casting slip. A positive effect of the addition of a pH additive can be observed in particular when using some organic carrier particles, as the diffusion of colouring substances out of the carrier particles (similar to the bleeding of wood, for example) can be prevented or at least reduced. As a result, the desired colour impression can be permanently guaranteed.

The additional component is preferably supplied as a powder, suspension, solution, paste, vapour or gas. If several further components are provided, these can be introduced together or separately. The use of several different individual components or mixtures of further components is also conceivable. These can be added together or one after the other.

However, pigments are of particular importance as an optional additional component. By adding a pigment to the coating compound, the filler particles can be given a desired colour. This makes it possible to produce particularly homogeneously coloured composite materials when using such fillers. When using coloured fillers, it is often even possible to dispense with adding colouring substances to the binder or other components of a casting slip in order to achieve the desired colour impression of the composite material that can be produced from it.

Adding a pigment to the coating compound also offers the possibility of producing differently coloured fillers in different processes. This in turn offers the possibility of using differently coloured fillers in a casting slip, for example to produce composite materials with a particularly natural appearance, such as granite-like materials.

Preferably, the silane, siloxane and/or silicone is selected from a group comprising linear, unbranched, branched, cyclic, mono-, di-, tri-silanes, mono- or multi-functionalized silanes such as alkyl-, amino-, methacryl-, vinyl- and/or epoxy-functionalized silanes, and others, as a pure substance or as a dilution and/or mixtures with itself or others. These silanes, siloxanes and/or silicones have been shown to be particularly suitable for achieving a sufficiently strong bond to the carrier particle and at the same time also ensuring firm embedding in a composite material.

The paraffin oil is preferably selected from a group comprising linear, branched, cyclic, mineral oil based materials and/or bio-based oil. Preferably, it has a viscosity in the section from 10 mPas up to 300 mPas. Additionally or alternatively, the use of the paraffin oil at elevated temperature and/or in diluted form and/or in mixtures with each other or with others may also be preferred.

In a preferred embodiment, the carrier particles are selected from a group comprising silicates, carbonates, sulphates, phosphates, oxides, carbon-based, natural or synthetic, crystalline or amorphous, geogenic or biogenic, or mixtures thereof. Further preferably, the carrier particles are selected from a group comprising kaolin, montmorillonite, talc, mica, quartz, sepiolite, nacrite, halloysite, dickite, K—, Ca—. Na or mixed feldspars, wollastonite, calcite, dolomite, barite, basalt, corundum, glass, borosilicate glass, quartz glass, ceramics, recycled or renewable raw materials and mixtures of these with each other and mixtures of these with other substances, wherein particularly preferred embodiments are carrier particles selected from a group consisting of quartz, feldspar, corundum, glasses, ceramics and renewable raw materials. Carrier particles selected from this group have been shown to be particularly suitable, since they meet the requirements for use as fillers in casting slips for the production of composite materials, at least with regard to their intrinsic colour, their colourability, their density, their dust formation behaviour and/or their hardness.

If a renewable raw material is used, it is preferably in the form of ground and/or crushed particles. This is due to the fact that renewable raw materials are often heterogeneous in shape and/or have an unsuitable size in the form in which they are produced or harvested. Preferably, they are therefore ground or crushed to the desired average particle size (measured by air jet sieving and/or Sedigraph) in the section of 0.1-300 μm, preferably 0.1-100, particularly preferably 0.1-45 μm. Alternatively or additionally, the particles can be brought to the desired particle size by a process selected from a group comprising washing, sorting, drying, crushing, grinding, cutting, bleaching, classifying, compacting, granulating, spray granulating, built-up granulating, fluidised bed processes and extruding. The desired particle size can be set at room temperature or cooled (cryo-breaking) in inert gas or atmospherically.

With regard to the particle sizes stated in the context of the present invention, it is noted that, unless explicitly stated otherwise, these are to be understood as the mean particle size (d₅₀), which was measured by a method suitable for this particle size, namely air jet sieving or by Sedigraph. It is also possible that the specified mean particle size is determined by several different methods. The results obtained using the different measurement methods often differ from each other. Preferably, however, the results of both measurement methods lie within the respective specified section, for example≤25 μm mean particle size of the filler.

The grain size of the carrier particles and/or the filler particles is preferably determined in liquid suspension, preferably in water and using Sedigraph (sedimentation method). For this purpose, each suspension to be measured in terms of particle size distribution is preferably treated with ultrasonic sound for 3 minutes in order to destroy loose agglomerates.

If a renewable raw material is used, the raw material is preferably selected from a group comprising kernels, shells, kernel derived products, shell derived products, bio-based plastics, bio-based monomers, bio-based polymers, lignin derived products, wood, wood derived products (e.g. chips, fibres, pulp, lignin, cork, leaves, needles), paper, cardboard, pressboard materials, MDF (medium density fibreboard), HDF (high density fibreboard), OSB (oriented strand board), fibre composites, impregnated fibre composites, insulation materials, short rotation coppice and their derived products (e.g. cotton, grass, straw, husks, bran, hemp fibres, sisal, jute), fruit and arable crops and their derived products (e.g. sugar beet fibres, molasses, pomace), fermentation materials, fermentation residues and similar (e.g. yeast cells, filtration residues from wine, juice and beer production), and materials of animal origin (e.g. wool, hair, bones) as well as combustion residues of the aforementioned materials, in particular ashes from the combustion of kernels and their derivatives, shells and their derivatives and husks. These raw materials have the advantage that they are available in large quantities and/or occur as waste material and are therefore very favourable.

In a preferred process variant, a compulsory mixer is used as the mixing device. Such mixers have proven to be particularly suitable for distributing the (carrier) particles so homogeneously that the coating can be applied homogeneously. Preferably, a mixer with a rotating mixing tool is used. Plough mixers, high-speed counterflow mixers or long gap mills have proven to be particularly suitable. The distribution of the particles is particularly good in a plough mixer. Plough mixers with a movable drum have proven to be particularly preferable. These have the advantage that the ploughshares can be attached to the drum and thus move together with the drum (during the mixing process). As a result, no separate drive of the plough is necessary, so that space remains inside the mixer, for example in the section of the rotation axis of the drum, for an insertion device for the coating compound.

In a preferred process variant, the coating compound is fed into the mixer at least in phases during the mixing process. This ensures that the coating compound is distributed homogeneously on the (carrier) particles. It is not necessary for the coating compound to be fed into the mixer during the entire mixing process. Rather, it is preferred that the introduction of the coating compound only begins when the mixing process has already started. As a result, the (still uncoated) carrier particles are already homogeneously distributed in the mixing chamber. In addition, these are in motion when the introduction of the coating compound begins, so that it is ensured that each particle comes into contact with the coating compound at least briefly. It is also possible to ensure that individual particles do not remain in contact with the coating compound for too long and thus bind an excessive amount of the coating compound.

Preferably, the coating compound is sprayed into the mixer at least in phases during the mixing process. Spraying has the advantage that the coating compound is already distributed over a comparatively large space when it is introduced into the mixer and, in particular, before it first comes into contact with the carrier particles to be coated. This means that a large number of particles can be coated at the same time and an excessive localised amount of coating compound can be prevented.

In particular, it is preferred that the coating compound is sprayed into the mixer by means of a plurality of nozzles. The use of several nozzles has been shown to be advantageous in order to distribute a large amount of coating compound over a large (interior) volume of the mixer in a short period of time. Nozzles are preferably spaced apart along an axis of rotation and/or have a different spraying direction radially from the axis of rotation. The arrangement of several nozzles at a distance from each other along the axis of rotation is particularly advantageous with a (substantially) horizontal axis of rotation, as the coating compound can thus be sprayed over a large proportion of the length of the mixer and thus onto many of the carrier particles to be coated. In addition, the nozzles can also be different in terms of their radial spraying direction in order to increase the area to be coated or the number of carrier particles that can be reached directly during spraying. Such measures can reduce the dwell time in the mixer. Particularly with a vertically arranged axis of rotation or only a slight inclination of the axis of rotation (of ≤45°, for example) in relation to the vertical, it is advantageous to align the nozzles in different radial spray directions, as this also allows as many carrier particles as possible to be reached directly by the coating compound during spraying.

Spraying the coating compound into the mixer using a large number of nozzles has also proven to be advantageous, as the coating compound is already finely distributed in the mixer and therefore less (mixing) energy is required to (evenly) distribute the coating compound. In this variant, the process can therefore be carried out at only a comparatively low rotational speed of the mixing device and still coat the carrier particles particularly quickly. At the same time, this also has the advantage that the process can be carried out with only low shear forces, which-possibly in addition to the reduction of fine dust during handling of the particulate filler described above-means that less abrasion occurs during mixing, which could potentially contribute to (fine) dust formation.

Preferably, the silane, siloxanes and/or silicones are mixed with the paraffin oil in a weight ratio of 80:20 to 40:60, preferably 70:30 to 50:50 and particularly preferably in a weight ratio of 60:40 to produce the coating compound. These ratios have proven to be particularly suitable for ensuring a safe and durable coating on the one hand, but also for enabling good and even wetting of the surface and, if necessary, of the pores of the carrier particles on the other. In addition, with mixing ratios in the above-mentioned section, the viscosity can be adjusted in such a way that homogeneous distribution and rapid introduction into the mixer are possible. The above-mentioned range limits may deviate from the above-mentioned values depending on the substances selected in each case and/or due to measurement inaccuracies and possibly evaporation of the paraffin oil (for example at the time of introduction and/or at the time of production of the coating compound). Preferably, however, such a deviation of the weight ratio is ±≤5, preferably ±≤3.

It should be noted that in the context of the present invention, all ratios (and thus all percentages) should be understood as referring to weight, unless explicitly stated otherwise. Furthermore, it is pointed out that the weight data as well as all quantities derived from a weight refer to the weight force in the Earth's gravitational field. All weights and quantities derived from weights should therefore be understood analogously as mass specifications (with the same numerical value as for the weight specifications) or the corresponding quantity derived from it (with the same numerical value as for quantities derived from weights).

Preferably, 0.1-10 parts by weight of coating compound are used per 100 parts by weight of carrier particles. This proportion has been shown to be sufficient to efficiently reduce dust formation and at the same time to be able to provide the filler particles cost-effectively. The optimum proportion of coating compound can vary in the above-mentioned section depending on the carrier particles used. However, it has been shown that 0.2-5 parts by weight of coating compound provide particularly good results in most cases. It is also preferable to use 0.5-2 parts by weight of coating compound and particularly preferable to use about 1 part by weight of coating compound. The values stated above may vary (for example for the reasons mentioned above) and/or deviate from the stated values at some points in time. Preferably, however, this deviation of the values is ±≤0.2, preferably ±≤0.1.

Preferably, the carrier particles coated with the coating compound are thermally treated. Thermal treatment can result in a stronger bond between the coating compound or individual components thereof and the carrier particle. The thermal treatment is preferably carried out over a period of 5 minutes to 5 hours, more preferably from 10 minutes to 2 hours, more preferably from 15 minutes to 1 hour and in particular preferably over about 30 minutes (preferably +≤10 minutes, more preferably ±≤5 minutes). These time periods have been shown to be particularly suitable for achieving sufficiently good distribution and firm bonding of the coating compound or individual components thereof to the carrier particle. In addition, the energy consumption and thus also the CO₂ emissions are low at these treatment times.

Alternatively or in addition to the above-mentioned time specifications for the thermal treatment, the thermal treatment is preferably carried out at a temperature in the section of 30-300° C., preferably 40-200° C., further preferably 50-150° C. and in particular preferably 70-100° C. These temperatures have been shown to be particularly suitable for achieving sufficiently good distribution and firm bonding of the coating compound or individual components thereof to the carrier particle. In addition, the energy consumption and thus also the CO₂ emissions are low at these temperatures.

Accordingly, the thermal treatment of the primary particles preferably takes place in an oven selected from a group comprising a rotary kiln, a deck oven, a fluidised bed oven, a grinding-drying oven and a spray-drying oven.

Furthermore, it can also be particularly advantageous to carry out the thermal treatment in a reducing or oxidising atmosphere. This can preferably be carried out depending on the properties of the primary particles and/or the desired product properties.

It is also possible to carry out a first or further drying of the carrier particles and/or the raw material at a first temperature and/or over a first time and to carry out a second or further drying of the filler particles at a second temperature and/or over a second time.

Advantageously, the carrier particles are adjusted to a desired (e.g. medium) particle size, for example ground, crushed or pulverised, classified or sifted. This can preferably be done using a pin mill, rotor mill, hammer mill, jet mill or a comparable mill. Preferably, this step is combined with prior and/or simultaneous drying of one of the raw materials used.

If the particulate filler obtained does not have the desired (average) particle size, its production can optionally be followed by additional wet or dry grinding, possibly combined with classification, e.g. cycloning or sifting.

In a preferred embodiment, the surface of the carrier particles is coated with organic and/or inorganic additives and/or mixed with other fillers or pigments.

In one variant, a first filler mixture with d₅₀≤25 μm is preferably combined with a second or further filler mixture of the same particle size or another, for example coarser, filler mixture (preferably with a particle size d₅₀ in the section of 25-100 μm). This has been shown to be particularly advantageous for producing a high degree of filling in a composite material.

Unless otherwise defined, the sequence of the individual process steps described above can be separated in time or space or combined with each other in any order that is not explicitly excluded. It is also conceivable that individual process steps can be carried out several times in succession or, if necessary, omitted or combined with one or more other process steps not mentioned above.

Preferably, the method is intended, suitable and/or designed to produce one of the particulate filler described below with slight dust formation and all the features described in connection with this particulate filler, individually or in combination with one another. The method can be carried out with all the features described in the context of the particulate filler individually or in combination with each other. Conversely, several or individual process steps may also be provided which result from the features described in connection with the particulate filler and the examples or are necessary in this context. In particular, it is envisaged that the particulate filler described below is produced according to the above process.

Another essential aspect of the present invention is a particulate filler with slight dust formation suitable for use in composite materials, wherein the filler comprises particles with an average particle size measured by air jet sieving and/or Sedigraph≤300 μm. In a preferred variant, a filler with an average particle size measured by air jet sieving and/or Sedigraph of 25-100 μm is used, further preferably 45-100 μm. In a further complementary or alternative preferred embodiment, the mean particle size, measured by air jet sieving and/or Sedigraph is in the order of <45 μm, especially <25 μm, preferably 0.1-45 μm, particularly preferably 0.1-25 μm. The particle size distributions of the fillers can be monomodal to multimodal. The particulate filler is characterised in that the particles each comprise a carrier particle whose average particle size measured by air jet sieving and/or Sedigraph is ≤300 μm and whose surface is coated at least in sections with a coating compound comprising a silane, siloxane and/or silicone as well as a paraffin oil and optionally one or more further components.

In a preferred embodiment, the carrier particles have an average particle size, measured by air jet sieving and/or Sedigraph of 25-100 μm, more preferably 45-100 μm. In a further complementary or alternative preferred embodiment, the average particle size, measured by air jet sieving and/or Sedigraph, is in the order of <45 μm, especially <25 μm, preferably 0.1-45 μm, particularly preferably 0.1-25 μm. The particle size distributions of the carrier particles used can be monomodal to multimodal.

Preferably, the carrier particles are selected from a group comprising silicates, carbonates, sulphates, phosphates, oxides, carbon-based, natural or synthetic, crystalline or amorphous, geogenic or biogenic, or mixtures thereof. Further preferably, the carrier particles are selected from a group comprising kaolin, montmorillonite, talc, mica, quartz, sepiolite, nacrite, halloysite, dickite, K—, Ca—. Na or mixed feldspars, wollastonite, calcite, dolomite, barite, basalt, corundum, glass, borosilicate glass, quartz glass, ceramics, recycled or renewable raw material and mixtures of these with each other and mixtures of these with other substances, wherein particularly preferred embodiments are carrier particles selected from a group consisting of quartz, feldspar, corundum, glasses, ceramics and renewable raw materials. This is preferably in the form of ground and/or crushed particles.

If a carrier particle comprises a renewable raw material, its raw material is preferably selected from a group comprising kernels, shells, kernel derived products, shell derived products, bio-based plastics, bio-based monomers, bio-based polymers, lignin derived products, wood, wood derivatives (e.g. chips, fibres, pulp, lignin, cork, leaves, needles), paper, cardboard, pressboard materials, MDF (medium density fibreboard), HDF (high density fibreboard), OSB (oriented strand board), fibre composites, impregnated fibre composites, insulation materials, short rotation coppice and their derived products (e.g. cotton, grass, straw, husks, bran, hemp fibres, sisal, jute), fruit and arable crops and their derived products (e.g. sugar beet fibres, molasses, pomace), fermentation materials, fermentation residues and similar (e.g. yeast cells, filtration residues from wine, juice and beer production), and materials of animal origin (e.g. wool, hair, bones) as well as combustion residues of the aforementioned materials, in particular ashes from the incineration of kernels and their derivatives, shells and their derivatives and husks.

In a preferred embodiment, the particulate filler has a dust value WR according to DIN EN 15051-3 measured in a counterflow downpipe of ≤100 mg/kg. Preferably, this dust value WR is ≤70 mg/kg, more preferably ≤60 mg/kg and particularly preferably ≤50 mg/kg.

Alternatively or additionally, the slight dust formation can also be indicated by the dust value Wi according to DIN EN 15051-3. In a preferred embodiment, the particulate filler has a dust value W according to DIN EN 15051-3 measured in a counterflow downpipe≤10,000 mg/kg, preferably ≤7,000 mg/kg, more preferably ≤5,000 mg/kg and particularly preferably ≤ 4,000 mg/kg.

This property can reduce the exposure of people to dust when handling the particulate filler.

Preferably, the coating compound or a coating formed from the coating compound comprises at least one further component. Preferably, one of the optional further components is selected from a group comprising pigments, rheological additives, adhesive agents, hydrophobing agents, hydrophilising agents and pH additives. In particular, it is preferred that at least one further component is a pigment.

By adding a pigment to the coating compound, a carrier particle can be provided with a coloured coating. A pigment is preferably added to the coating compound in a weight proportion of up to 20%, preferably in the section 0.2-15%, particularly preferably in the section 0.5-10%. This enables homogeneous colouring of composite materials when a particulate filler obtained in this way is used to produce them. A pigment is preferably selected from a group comprising titanium dioxide, manganese dioxide, iron oxide-based pigment, carbon black-based pigments and organic pigment. In particular, a coating compound containing a white pigment is preferred. This enables white particulate fillers to be obtained, such as those used in large quantities in the manufacture of sanitary furniture such as washbasins, bathtubs and shower trays.

Preferably, the particulate filler is characterised by low fading behaviour. This is characterised by a change in the L* value of ≤20%, preferably ≤15% and particularly preferably ≤10% in relation to the L* value of this sample before this test when water at a temperature of 90° C. flows around the test specimen(s) for 8 hours.

In addition or alternatively, a change in the a* value of a test specimen after flowing water at a temperature of 90° C. around the test specimen(s) for 8 hours is ≤0.5, preferably ≤ 0.1 and particularly preferably ≤0.05 compared to the a* value of this test specimen before this test and/or a change in the b* value of a test specimen is ≤1.0, preferably ≤0.5, more preferably ≤0.3 and particularly preferably ≤0.2 compared to the b* value of this test specimen before this test.

Another essential aspect of the invention is a use of a particulate filler as described above as a filler in a casting slip and/or a composite material. A use of a particulate filler as described above may impart advantageous properties to a composite material and/or make the composite material less expensive. In particular, a use of a particulate filler as described above may provide a composite material with a high degree of filling, a homogeneous colour, a pleasant feel and/or a matt surface. Furthermore, such a filler could make a composite material more resistant to damage such as chipping, cracking, scratching and/or discolouration. Such fillers can also improve chemical resistance and/or temperature resistance (in particular to hot-cold cycling conditions, as required for kitchen sinks).

Optionally, the composite material also contains another filler as a further component. This can have a coarser, finer or identical average particle size. Preferably, the average particle size of the further filler is in the order of 0.1-1.0 mm, preferably 0.1-0.8 mm, more preferably 25-100 μm. The further filler is preferably a quartz sand, which can either be colour-coated or not coloured, and these quartz sands can additionally or alternatively be organically modified, for example silanised.

Preferably, such a casting slip comprises at least one binder, wherein the binder is preferably selected from a group comprising an unsaturated liquid curable polyester resin, a liquid curable casting resin containing MMA and/or PMMA, a curable melamine resin, a curable formaldehyde resin, a curable epoxy resin and a polyurethane resin. Mixtures of several polymers and/or resins are also conceivable.

In a preferred embodiment, the casting slip contains at least one additive, preferably a pigment and/or a rheological additive.

Another essential aspect of the invention is a composite material comprising a binder and a filler as described above.

Preferably, such a composite material is formed into a component selected from a group comprising a kitchen sink, washbasin, shower tray, bathtub, worktop, floor, wall or ceiling panel, floor, wall or ceiling tile, moulded part for furniture construction and moulded part for model construction.

### BRIEF DESCRIPTION OF THE DRAWINGS

FIG. 1 shows a comparison of the distribution of different casting slips in a test mould.

### DETAILED DESCRIPTION OF THE INVENTION

Further advantages of exemplary processes and the particulate filler are illustrated with reference to the following examples. However, individual features of the exemplary processes and particulate fillers can also be carried out or occur independently of other process steps or properties mentioned in the respective example.

### Example 1: Comparison of Different Compositions of Coating Compounds

Quartz flour was used as a carrier particle for the tests in Example 1. This is known for its strong dust formation during handling.

The carrier particles were coated with different proportions of a coating compound. The amounts of coating compound used were 0.5% or 1.0% by mass in relation to the amount of carrier particles used.

The coating compound contained silane and paraffin oil in different ratios. These were varied from 60:40 to 50:50 to 40:60 in this series of tests.

In all cases, particulate fillers with slight dust formation were obtained. The colour changes of the fillers obtained were examined by continuous flow (over 8 hours) with hot water (90° C.) (referred to as hot water test in Table 1).

The results of the colour tests are shown in Table 1.

TABLE 1

| | Sample 1 | | Sample 2 | | Sample 3 | | Sample 4 | | Sample 5 | | Sample 6 | |
|---|---|---|---|---|---|---|---|---|---|---|---|---|
| Quantity of carrier | 500 | g | 500 | g | 500 | g | 500 | g | 500 | g | 500 | g |
| particles | | | | | | | | | | | | |
| Quantity of silane | 1.5 | g | 3.0 | g | 1.25 | g | 2.5 | g | 1.0 | g | 2.0 | g |
| Quantity of paraffin | 1.0 | g | 2.0 | g | 1.25 | g | 2.5 | g | 1.5 | g | 3.0 | g |
| oil | | | | | | | | | | | | |

| | | | | | | | |
|---|---|---|---|---|---|---|---|
| before Hot | L* value | 26.89 | 26.89 | 26.46 | 26.83 | 26.01 | 26.81 |
| water test | a* value | 0.18 | 0.18 | 0.18 | 0.18 | 0.26 | 0.18 |
| | b* value | −0.40 | −0.39 | −0.60 | −0.47 | −0.33 | −0.60 |
| after hot | L* value | 27.41 | 26.46 | 30.27 | 30.96 | 28.15 | 30.54 |
| water test | a* value | 0.17 | 0.21 | 0.06 | 0.04 | 0.06 | 0.03 |
| | b* value | −0.28 | −0.07 | −0.57 | −0.59 | −0.42 | −0.67 |

The results show that very slight changes in colour occur, particularly in samples 1 and 2.

### Example 2: Comparison of Equal Proportions of Coating Compounds on Quartz Powders of Different Finenesses

Quartz flour was also used as a carrier particle for the tests according to Example 2. In this case, quartz flours of different finenesses were used. The carrier particles were coated with a coating compound containing silane and paraffin oil in a 60:40 ratio. The proportion of the coating compound used was kept constant at 2.5% by mass in relation to the amount of carrier particles used in all tests.

The dusting tendency was investigated as a reference measurement method in accordance with DIN EN 15051-3 “Measurement of the dustiness of bulk materials-Part 3: Continuous drop method”. The results are shown in Table 2.

TABLE 2
Measurement result ranges, dust measurement parameters
W_{I} and W_{R} and classification according to DIN EN 15051 Part 3

| | QM1 | QM2 | QM3 |
|---|---|---|---|
| D50, μm | 60 | 37 | 15 |
| Bulk density, g/cm3 | 1.3 | 1.1 | 0.8 |
| Number of measurements | 3 | 3 | 3 |
| Measuring time. min | 30 | 30 | 30 |
| H2O content, Ma-% | <0.1 | <0.1 | <0.1 |
| A-dust value W_{R}, original | 20-70 | 71-300 | >300 |
| A-dust, dusting tendency, | Slightly | Dusting | Highly |
| original | dusting | | dusting |
| A dust value W_{R}, after | <20 | <20 | 20-70 |
| surface coating | | | |
| A-dust, dusting tendency, | Low in | Low in | Slightly |
| after surface coating | dust | dust | dusting |
| E-dust value W_{I}, original | 1000-4000 | 4000-15000 | >15000 |
| E-dust, dusting tendency, | Low | Dusting | Highly |
| original | dusting | | dusty |
| E-dust value W_{I}, after | <1000 | <1000 | 1000-4000 |
| surface coating | | | |
| E-dust, dusting tendency, | Low in | Low in | Slightly |
| after surface coating | dust | dust | dusting |

In all cases, particulate fillers with significantly reduced dust formation according to DIN EN 15051 part could be obtained.

### Example 3: Comparison of Different Proportions of Coating Compounds

Quartz flour was also used as carrier particles for the tests according to Example 3. The carrier particles were coated with a coating compound containing silane and paraffin oil in a 60:40 ratio. The amount of coating compound used was varied from 2.5% or 10% by mass in relation to the amount of carrier particles used.

In all cases, particulate fillers with slight dust formation were obtained. The fillers obtained were examined for their colour changes during hot water treatment, analogous to the measurements in Example 1.

The results of the colour tests are shown in Table 3. As the conditions for preparing the fillers differed slightly from those in Example 1 (for example, the batch size was reduced to only 100 g instead of 500 g of carrier material), the results of samples 1 and 2 are not listed again, although they could supplement Table 3 due to the coating composition of 60:40 also used.

TABLE 3

| | | Sample | Sample | Sample |
|---|---|---|---|---|
| | | 7 | 8 | 9 |
| Quantity of coating composition (quantity | | 2.5 g | 5.0 g | 10.0 g |
| ratio silane:paraffin oil = 60:40) per | | | | |
| 100 g carrier particles | | | | |
| before hot | L* value | 27.73 | 27.77 | 27.86 |
| water test | a* value | 0.15 | 0.16 | 0.14 |
| | b* value | −0.49 | −0.52 | −0.51 |
| after hot | L* value | 28.90 | 29.18 | 29.15 |
| water test | a* value | 0.14 | 0.16 | 0.18 |
| | b* value | −0.34 | −0.39 | −0.34 |

The results show that the L* value before hot water treatment is slightly higher for samples 7-9 than for samples 1-6 from Example 1. This can be explained by the thicker and/or more homogeneous coating due to the increased coating mass fraction. However, even with the higher coating mass percentages of samples 7-9, the changes in colour that occur are extremely slight.

### Example 4: Experiments on the Colourability of Different Carrier Particles

The investigations into the colourability of various carrier particles were only carried out on selected carrier particles as examples. The evaluation was carried out qualitatively by visual inspection.

Samples of different carrier particles (namely olive stone meal, a quartz flour and a thermally treated quartz (flour)) were each coated in an intensive high-speed mixer for 2 minutes at 3000 rpm with different pigments (Hombitan dWS (titanium dioxide) and CM4 (manganese oxide)) and/or pigment concentrations as well as one and a coating compound containing silane and paraffin oil in a 60:40 ratio.

All the materials analysed were very easy to coat. All particles could be coloured. Even with particularly small average particle sizes of the carrier particles, dust formation could be reduced. The visually higher colour depth of coloured carrier particles with particularly small average particle sizes (e.g. quartz powder) was striking.

### Example 5: Production of a Composite Material

For this test, 500 kg of carrier particles (quartz powder) were placed in a preheated mixer with a horizontal axis of rotation and the coating compound was then injected into the mixer. The coating compound used contained a black pigment and 5.2 kg (˜1 mass % based on the carrier particle mass) of a mixture of silane and paraffin oil in a 60:40 ratio.

The mixture was mixed further after the coating compound had been completely added to ensure homogeneous wetting of the carrier particles. However, the mixing process was paused several times to allow the coating compound to adhere securely to the carrier particles. In addition, these pauses can reduce the energy input and thus also the total shear forces introduced.

The filler obtained was added to a polyester resin mixed with a deaerator while stirring. The quantities were selected so that the filler content was 70 percent by mass. After complete mixing, a hardener was added, in this case a peroxide. After this was added, the mixture was stirred for a further 30 seconds and then deaerated. The resulting casting slip was moulded into a slab, which was tempered at 90° C. for 4 hours. After cooling the resulting composite sheet (referred to below and in Table 4 as “Sheet 1”), a colour measurement was carried out.

The colour measurement was repeated after a hot water treatment similar to that described in connection with examples 1 and 3 (8 hours of hot water at 90° C. flowing around the plate). The results of the colour measurement before and after this treatment are shown in Table 4.

TABLE 4

| | | Sheet 1 |
|---|---|---|
| before hot | L* value | 26.18 |
| water test | a* value | 0.14 |
| | b* value | −0.32 |
| after hot | L* value | 31.1 |
| water test | a* value | −0.07 |
| | b* value | −0.2 |

The results presented show that the colour change in a composite material produced using the particulate fillers described above is very small. The L* value increases slightly more than was measured for particles not moulded into a composite material. This is attributed to effects of the binder. The changes in the a* value and the b* value before and after the hot water test are extremely small at −0.21 (a* value) and 0.12 (b* value) respectively.

### Example 6: Chemical Resistance

A Sheet 2 produced in the same way as Sheet 1 was subjected to a chemical resistance test in accordance with DIN EN 13 310. The chemicals tested were: 10% acetic acid, 5% caustic soda, 70% ethanol, sodium hypochlorite solution, 1% methylene blue solution, black tea, red wine, black coffee, hair dye, vinyl resin paint and lipstick. The chemical resistance was determined by comparison with a composite material known from the state of the art. The results are shown in Table 6, where the entry “stain” means that the respective substance has caused a visually perceptible change to the surface of the composite material after 36 hours of exposure. Table 6 shows the results of three different post-treatments. On the left after rinsing the respective panel and careful dabbing dry, in the centre after subsequent rubbing with a damp cloth and subsequent dabbing dry and on the right after treatment with scouring powder and subsequent dabbing dry.

TABLE 6

| | | | Comparison | Sheet 2 | Comparison | Sheet 2 |
|---|---|---|---|---|---|---|
| Chemical/Test | Comparison | Sheet 2 | Wipe with a | | Rub down with | |
| substance | Rinse off | | damp cloth | | scouring powder | |
| Acetic acid 10% | Stain | | Stain | | | |
| Sodium hydroxide | | | | | | |
| solution 5% | | | | | | |
| Ethanol 70% | | Stain | | Stain | | |
| Sodium hypochlorite | | | | | | |
| Methylene blue 1% | Stain | Stain | | | | |
| Sodium chloride | | | | | | |
| solution 85 g/L | | | | | | |
| Tea | | | | | | |
| Red wine | | | | | | |
| Coffee | | | | | | |
| Hair dye | Stain | Stain | Stain | Stain | Stain | |
| Colour, vinyl resin | Stain | Stain | | | | |
| Lipstick | Stain | Stain | Stain | Stain | | |

As can be seen in Table 6, the chemical resistance of Sheet 2 essentially corresponds to that of the reference product. When treated with 10% acetic acid, no stain was recognisable after rinsing and even after rubbing, unlike with the reference product. Sheet 2 performed slightly worse when treated with ethanol, as a stain was visible both after rinsing and after wet rubbing. It is worth noting that after treatment with scouring powder, hair dye could even be removed from Sheet 2 without a recognisable stain, whereas a stain remained on the comparison product.

### Example 7: Thermal Shock Resistance Test According to DIN EN 13310

The thermal shock resistance of a test specimen was tested in accordance with DIN EN 13310. For this purpose, the test specimen is subjected to a repeated temperature change between 95° C. and 15° C. For each cycle, the test specimen is exposed to 95° C. hot water for 90 seconds, then left to rest for 30 seconds and then exposed to 15° C. cold water for 90 seconds. After 30 seconds of rest, the next cycle begins. The entire test consists of 1,000 of these cycles without further interruptions.

The test specimen with the exemplary filler according to the invention passed this test.

### Example 8: Rheology/Flow Behaviour

A sample of the casting slip obtained in example 5 was poured into a test mould and the distribution of the casting slip in the test mould was examined. The result was compared with a casting slip known from the state of the art, which was also used to produce the reference product used in example 6.

The better flow behaviour of the exemplary casting slips with a filler according to the invention and, in particular, the better distribution of the casting slip in the test shell is shown in the figure. It shows:

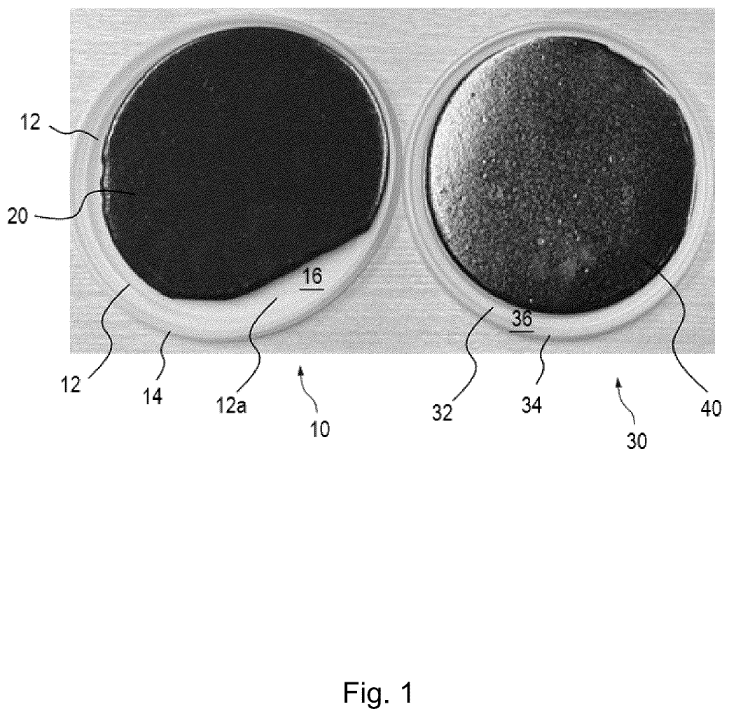

FIG. 1: a comparison of the distribution of different casting slips in a test mould.

FIG. 1 shows a comparison of the distribution of different casting slips 20, 40 in a test dish 10, 30. In the dish 10 shown on the left, a casting slip 20 known from the prior art is shown. As can be seen, the casting slip 20 is not evenly distributed in the dish 10. In sections 12 near the edge 14 of the dish 10, the dish bottom 16 can still be recognised, as the casting slip 20 cannot reach these sections 12 due to its low flowability. In the section 12a recognisable at the bottom right of the dish 10, even a comparatively large section 12a is not wetted by the casting slip 20.

In contrast, the result of a test of the flow behaviour of a casting slip 40 with an exemplary filler according to the invention in a test shell 30 is shown on the right. As can be seen in particular in comparison with the comparative example shown on the left, the casting slip 40 is distributed much more evenly in the dish 30. The sections 32 near the edge 34 of the dish 30, in which the dish bottom 36 can still be recognised, as the casting slip 40 does not extend there, are extremely narrow. The flow behaviour of the casting slips 40 with an exemplary filler according to the invention is consequently better. It can be expected that even more complicated three-dimensional shapes of composite materials can be realised with such a casting slip 40.

The applicant reserves the right to claim all features disclosed in the application documents as being essential to the invention, provided that they are new compared to the prior art, either individually or in combination. It should also be noted that the individual figures also describe features which may be advantageous in themselves. The skilled person immediately recognises that a particular feature described in a figure can also be advantageous without the adoption of further features from this figure. Furthermore, the skilled person recognises that advantages can also result from a combination of several features shown in individual figures or in different figures.

Having now fully described the present invention in some detail by way of illustration and examples for purposes of clarity of understanding, it will be obvious to one of ordinary skill in the art that the same can be performed by modifying or changing the invention within a wide and equivalent range of conditions, formulations and other parameters without affecting the scope of the invention or any specific embodiment thereof, and that such modifications or changes are intended to be encompassed within the scope of the appended claims.

When a group of materials, compositions, components or compounds is disclosed herein, it is understood that all individual members of those groups and all subgroups thereof are disclosed separately. Every formulation or combination of components described or exemplified herein can be used to practice the invention, unless otherwise stated. Whenever a range is given in the specification, for example, a temperature range, a time range, or a composition range, all intermediate ranges and subranges, as well as all individual values included in the ranges given are intended to be included in the disclosure. Additionally, the end points in a given range are to be included within the range. In the disclosure and the claims, “and/or” means additionally or alternatively. Moreover, any use of a term in the singular also encompasses plural forms.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. Any recitation herein of the term “comprising”, particularly in a description of components of a composition or in a description of elements of a device, is understood to encompass those compositions and methods consisting essentially of and consisting of the recited components or elements.

One of ordinary skill in the art will appreciate that starting materials, device elements, analytical methods, mixtures and combinations of components other than those specifically exemplified can be employed in the practice of the invention without resort to undue experimentation. All art-known functional equivalents, of any such materials and methods are intended to be included in this invention. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. The invention illustratively described herein suitably may be practiced in the absence of any element or elements, limitation or limitations which is not specifically disclosed herein. Headings are used herein for convenience only.

All publications referred to herein are incorporated herein to the extent not inconsistent herewith. Some references provided herein are incorporated by reference to provide details of additional uses of the invention. All patents and publications mentioned in the specification are indicative of the levels of skill of those skilled in the art to which the invention pertains. References cited herein are incorporated by reference herein in their entirety to indicate the state of the art as of their filing date and it is intended that this information can be employed herein, if needed, to exclude specific embodiments that are in the prior art.

1. A method for producing a particulate filler with slight dust formation suitable for use in composite materials, wherein the mean particle size of the filler as measured by air jet sieving and/or Sedigraph is ≤300 μm, and wherein the method comprises the steps of:
providing carrier particles which have an average particle size measured by air jet sieving and/or Sedigraph≤300 μm,
providing a silane, siloxane and/or silicone,
preparing a paraffin oil,
preparing a liquid coating compound by mixing the silane, siloxane and/or silicone and the paraffin oil and optionally other components, and
coating the carrier particles with the coating compound in a mixing device.

2. The method according to claim 1, wherein the carrier particles are selected from a group consisting of silicates, carbonates, sulphates, phosphates, oxides, carbon-based particles, natural or synthetic particles, crystalline or amorphous particles, geogenic or biogenic particles, and mixtures thereof.

3. The method according to claim 1, wherein the carrier particles comprise kaolin, montmorillonite, talc, mica, quartz, sepiolite, nacrite, halloysite, dickite, K—, Ca—, Na— or mixed feldspars, wollastonite, calcite, dolomite, barite, basalt, corundum, glass, borosilicate glass, quartz glass, a ceramic, a recycled or renewable raw material, or mixtures thereof.

4. The method according to claim 3, wherein the carrier particles comprise a renewable raw material comprising ground and/or crushed particles, kernels, shells, kernel derived products, shell derived products, bio-based plastics, bio-based monomers, bio-based polymers, lignin derived products, wood, wood derived products, paper, cardboard, pressboard materials, MDF (medium density fibreboard), HDF (high density fibreboard), OSB (oriented strand board), fibre composites, impregnated fibre composites, insulating materials, short rotation coppice and derivatives thereof, fruit and arable crops and derivatives thereof, fermentation materials, fermentation residues and the like, materials of animal origin, and combustion residues of the aforementioned materials.

5. The method according to claim 1, wherein
the silane is selected from a group consisting of linear, unbranched, branched, cyclic, mono-, di-, tri-silanes, mono- or polyfunctionalised silanes, wherein the silane is present as a pure substance or as a dilution and/or mixtures with itself or others.

6. The method according to claim 1, wherein the silane is a liquid siloxane which is linear or cyclic.

7. The method according to claim 1, wherein the silane is a silicone having a molecular mass of 160 to 150.000 g/mol, a density of 0.76 to 1.07 g/cm³, and/or a viscosity of 0.6 to 1,000,000 mPa-s.

8. The method according to claim 1, wherein the mixing device is a compulsory mixer, a mixer with a rotating mixing tool, a plough mixer, or a plough mixer with a movable drum.

9. The method according to claim 1, wherein the coating compound is fed into the mixer at least in phases during the mixing process.

10. The method according to claim 1, wherein the silane, siloxane and/or silicone is mixed with the paraffin oil in a weight ratio of 80:20 to 40:60 to produce the coating compound.

11. The method according to claim 1, wherein 0.1-10 parts by weight of coating compound are used per 100 parts by weight of the carrier particles.

12. The method according to claim 1, wherein the carrier particles coated with the coating compound are thermally treated, over a period of 5 minutes to 5 hours, at a temperature between 30-300° C.

13. A particulate filler with slight dust formation suitable for use in composite materials, the filler comprising particles having an average particle size measured by air jet sieving and/or Sedigraph≤300 μm, wherein the particles each comprise a carrier particle whose mean particle size measured by air jet sieving and/or Sedigraph is ≤300 μm and whose surface is coated at least in sections with a coating compound comprising a silane, siloxanes and/or silicones as well as a paraffin oil and optionally one or more further components.

14. The particulate filler according to claim 13, wherein the carrier particles are selected from a group consisting of silicates, carbonates, sulphates, phosphates, oxides, carbon-based particles, natural or synthetic particles, crystalline or amorphous particles, geogenic or biogenic particles, and mixtures thereof.

15. The particulate filler according to claim 13, wherein the carrier particles comprise kaolin, montmorillonite, talc, mica, quartz, sepiolite, nacrite, halloysite, dickite, K—, Ca—, Na— or mixed feldspars, wollastonite, calcite, dolomite, barite, basalt, corundum, glass, borosilicate glass, quartz glass, a ceramic, a recycled or renewable raw material, or mixtures thereof.

16. The particulate filler according to claim 13, wherein the carrier particles comprise a renewable raw material comprising ground and/or crushed particles, kernels, shells, kernel derived products, shell derived products, bio-based plastics, bio-based monomers, bio-based polymers, lignin derived products, wood, wood derived products, paper, cardboard, pressboard materials, MDF (medium density fibreboard), HDF (high density fibreboard), OSB (oriented strand board), fibre composites, impregnated fibre composites, insulating materials, short rotation coppice and derivatives thereof, fruit and arable crops and derivatives thereof, fermentation materials, fermentation residues and the like, materials of animal origin, and combustion residues of the aforementioned materials.

17. The particulate filler according to claim 13, wherein the particulate filler has a dust value WR according to DIN EN 15051-3 measured in a counterflow downpipe of ≤100 mg/kg.

18. The particulate filler according to claim 13, wherein the particulate filler has a dust value W according to DIN EN 15051-3 measured in a counterflow downpipe of ≤10,000 mg/kg.

19. The particulate filler according to claim 13, wherein the particulate the filler has an average particle size, measured by air jet sieving and/or Sedigraph, of 25-100 μm the particle size distributions of the fillers preferably being mono or multimodal.

20. A casting slip or composite material comprising the particulate filler according to claim 13.

21. A composite material comprising a binder and the particulate filler according to claim 13.

22. An object comprising the particulate filler according to claim 13, wherein the object is selected from a group comprising a kitchen sink, a worktop, a bathtub, a washbasin, a tile, a shower tray and a floor covering.
